(19) United States
(12) Patent Application Publication
(10) Pub. No.: US 2011/0157816 A1
(43) Pub. Date: Jun. 30, 2011

(54) SMALL-SIZED COMPUTER HOST

(75) Inventors: XIAO-FENG MA, Shenzhen City (CN); CHIA-SHIN CHOU, Tu-Cheng (TW); AN-GANG LIANG, Shenzhen City (CN)

(73) Assignees: HONG FU JIN PRECISION INDUSTRY(ShenZhen) CO., LTD., Shenzhen City (CN); HON HAI PRECISION INDUSTRY CO., LTD., Tu-Cheng (TW)

(21) Appl. No.: 12/765,869

(22) Filed: Apr. 23, 2010

(30) Foreign Application Priority Data
Dec. 24, 2009 (CN) 200910312179.3

(51) Int. Cl. G06F 1/20

(52) U.S. Cl. 361/679.48

(57) ABSTRACT

A computer host includes a enclosure, a circuit board, and a cooling assembly. The enclosure includes a first sidewall and a second sidewall opposite to the first sidewall. The first sidewall defines a plurality of vents. The circuit board is received in the enclosure. A central processing unit and at least one memory chip are plugged into corresponding slots of the circuit board. The cooling assembly includes at least one fan and an airflow guide. The at least one fan is positioned adjacent to the second sidewall and is aligned with the vents. Each of the at least one fan defines an outlet. The airflow guide is positioned on the circuit board with the outlet of the fan being sealed with edges defining entrances of the airflow guide.

### BACKGROUND

1. Technical Field

The present disclosure generally relates to computer hosts and, particularly, to a small-sized computer host having high efficiency in heat dissipation.

2. Description of Related Art

With fast development of computer technology, computer hosts are made smaller and smaller, but advanced central processing units (CPUs) and memory chips operate increasingly faster and thereby generate increasingly more heat. As such, more effective heat dissipation of computer hosts is still a long-felt need.

Therefore, it is desirable to provide a computer host which can provide effective heat dissipation.

### BRIEF DESCRIPTION OF THE DRAWINGS

Many aspects of the present computer host can be better understood with reference to the accompanying drawings. The components in the drawings are not necessarily drawn to scale, the emphasis instead being placed upon clearly illustrating the principles of the present computer host. Moreover, in the drawings, like reference numerals designate corresponding parts throughout the several views, and all the views are schematic.

FIG. 1 is an assembled, schematic view of a computer host according to an exemplary embodiment.

FIG. 2 is an exploded, isometric view of the computer host of FIG. 1.

### DETAILED DESCRIPTION

Embodiments of the present computer host will now be described in detail below and with reference to the drawings.

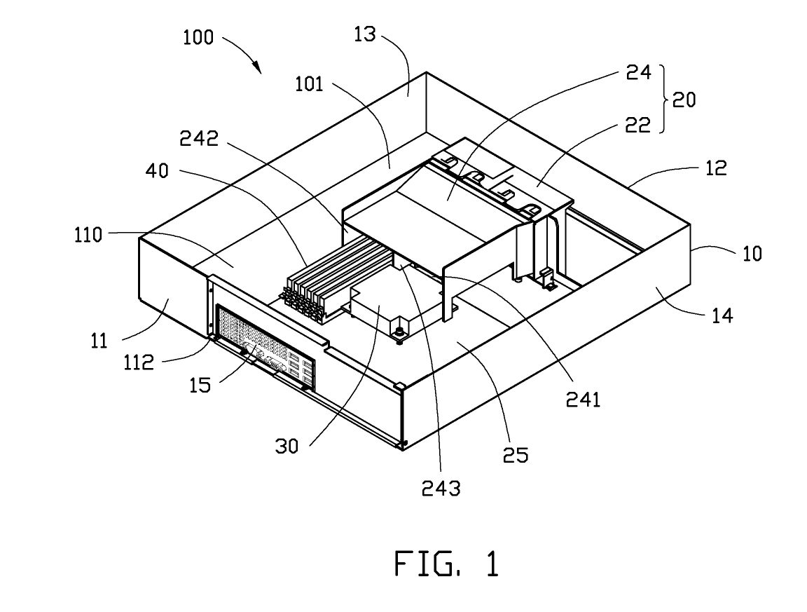

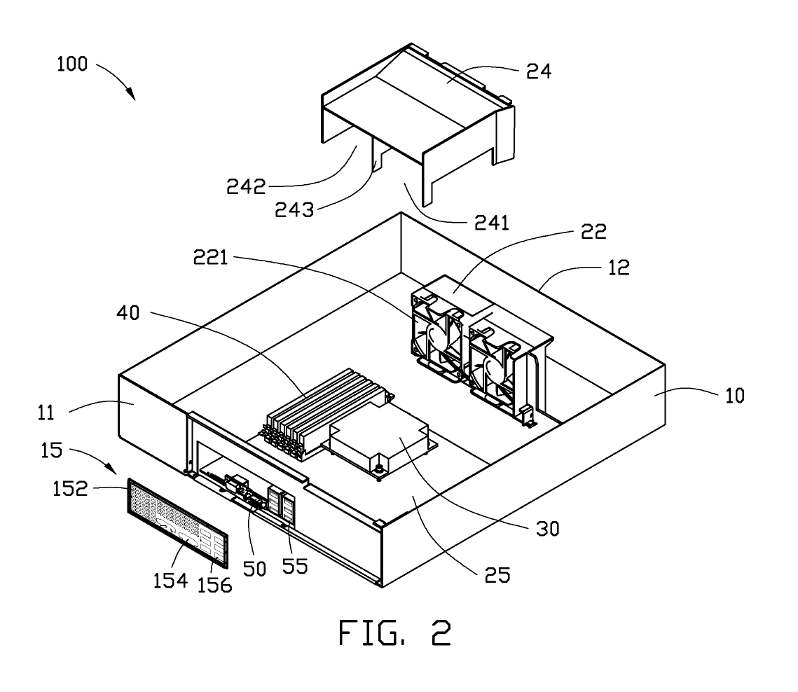

Referring to FIGS. 1-2, a computer host 100 includes an enclosure 10 housing a cooling assembly 20, a circuit board 25. The circuit board 25 includes heat generating components, as an example, a central processing unit (CPU) 30, and at least one memory chip 40, both of which are plugged into corresponding slots of the circuit board 25.

The enclosure 10 includes a bottom plate 101, a first sidewall 11, a second sidewall 12, a third sidewall 13, and fourth sidewall 14. The bottom plate 101 and the four side walls 11,12,13,14 cooperatively define a receiving space 110 for receiving the cooling assembly 20 and the circuit board 25. The first sidewall 11 is formed opposite to the second sidewall 12, while the third sidewall 13 is formed opposite to the fourth sidewall 14. The first sidewall 11 defines an opening 112 generally at the center thereof. The enclosure 10 further includes a cooling panel 15. The cooling panel 15 is embedded in the opening 112 via screws. The computer host 100 further includes at least one I/O port 50 and at least one universal serial bus (USB) interface 55. The cooling panel 15 defines a plurality of vents 152, at least one first opening 154 shaped to receive the at least one I/O port 50, and at least one second opening 156 shaped to receive the at least one USB interface 55. The at least one I/O port 50 and the at least one USB interface 55 are electrically coupled to the circuit board 25.

In an alternative embodiment, the cooling panel 15 can be integrally formed with the enclosure 10.

The cooling assembly 20 includes at least one fan 22 and an airflow guide 24. In this embodiment, the cooling assembly 20 includes two fans 22. The two fans 22 are arranged side by side on the bottom sidewall 101, aligned with the opening 112 and adjacent to the second sidewall 12. Each of the fans 22 defines an air outlet 221 facing the first sidewall 11 in alignment with the cooling panel 15, so that airflow produced by the two fans 22 can flow through the airflow guide 24 over and around the circuit board 25, then on through the vents 152 of the cooling panel 15 with extremely low air resistance thus efficiently carrying heat produced by components of the circuit board 25 away. The airflow guide 24 is made of high thermally conductive material, such as aluminum, magnesium, or aluminum-magnesium alloy so that heat produced by the circuit board 25 can transfer from the point of contacts between the circuit board 25 and the airflow guide 24 to then be dissipated by the airflow as it is vented out the vents 152. In the present embodiment, the airflow guide 24 is made of aluminum. In this embodiment, the airflow guide 24 further includes a board 243 placed inside the airflow guide 24 to separate the airflow guide 240 into first and second airflow passages 241, 242, the first passage 241 is adjacent to the second passage 242. The board 243 is integrally formed with the airflow guide 24. The two outlets 221 of the two fans 22 are sealed by the edges defining entrances of the first airflow passage and second airflow passages 241, 242, respectively.

In an alternative embodiment, the cooling assembly 20 may include only one fan 22, and the board 243 omitted.

Unlike a conventional computer host 100, the two fans 22 establish airflow from the outlets 221 through the airflow guide 24 over and around heat generating components of the circuit board 25, and to the cooling panel 15, efficiently bringing heat dissipated by the airflow guide 24 out of the enclosure 10 via the plurality of vents 152 of the cooling panel 15. With the airflow guide 24 being made of high thermally conductive material, and the airflow passages 241, 242 configured to separately handle the heat from the CPU 30, and the memory chip 40, as well as heat produced at the at least one I/O port 50, and the at least one USB interface 55, space is save and heat dissipation is accomplished cheaply and simply.

It will be understood that the above particular embodiments is shown and described by way of illustration only. The principles and the features of the present invention may be employed in various and numerous embodiments thereof without departing from the scope of the invention as claimed. The above-described embodiments illustrate the scope of the invention but do not restrict the scope of the invention.

What is claimed is:

1. A computer host comprising:
a enclosure comprising a first sidewall and a second sidewall opposite to the first sidewall, the first sidewall defining a plurality of vents;
a circuit board received in the enclosure, a central processing unit and at least one memory chip being plugged into corresponding slots of the circuit board;
a cooling assembly comprising at least one fan and an airflow guide, the at least one fan positioned adjacent to the second sidewall and aligned with the vents, each of the at least one fan defining an outlet, the airflow guide positioned on the circuit board with the outlet of the fan being sealed with edges defining entrances of the airflow guide.

2. The computer host of claim 1, wherein the first sidewall defines an opening at the center thereof, the enclosure further comprising a cooling panel embedded in the opening, the plurality of vents are defined on the cooling panel.

3. The computer host of claim 2, further comprising at least one I/O port and at least one universal serial bus (USB) interface, the cooling panel further defines at least one first opening shaped to receive to the at least one I/O port for insertion of the corresponding I/O port, and at least one second opening shaped to receive the USB interface.

4. The computer host of claim 1, wherein the least one fan comprises two fans arranged side by side.

5. The computer host of claim 4, wherein the airflow guide further comprises a board placed inside the airflow guide to separate the airflow guide into a first and a second airflow passage, the two outlets of the two fans are sealed by the edges defining entrances of the first airflow passage and second airflow passages respectively.

6. The computer host of claim 5, wherein the clapboard is integrally formed with the airflow guide.

7. The computer host of claim 1, wherein the airflow guide is made of high thermally conductive material.
